(19) United States
(12) Patent Application Publication
(10) Pub. No.: US 2008/0172371 A1
(43) Pub. Date: Jul. 17, 2008

(54) METHODS AND COMPUTER PROGRAM PRODUCT FOR SEARCHING AND PROVIDING ACCESS TO WEB-SEARCHABLE DOCUMENTS BASED ON KEYWORD ANALYSIS

(75) Inventors: Timothy P. Clark, Rochester, MN (US); Zachary A. Garbow, Rochester, MN (US); Kevin G. Paterson, San Antonio, TX (US); Richard M. Theis, Sauk Rapids, MN (US); Brian P. Wallenfelt, Plymouth, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/623,834

(22) Filed: Jan. 17, 2007

(51) Int. Cl. G06F 7/06; G06F 17/30

(52) U.S. Cl. 707/5; 707/E17.014

(57) ABSTRACT

Web-searchable documents are made accessible to user based on user relations to the document owner. In response to an Internet search query from a user including at least one search term, a document in a search index of documents is analyzed. Keywords within the document are assigned group priority ratings. The group priority ratings are indicative of groups of users that the document owner is willing to share documents with. The group ratings may be assigned by the document owner based, for example, on the sensitivity of personal nature of the keywords. The user's relation rating to an owner of the document is determined, and the search term in the query is compared only to those indexed keywords within the document that have a group priority rating that is less than or equal to the user's relation rating to the owner of the document. An overall document ranking may be determined based on the comparison of the search term to the indexed keywords. The steps of analyzing, determining, comparing, and determining an overall document ranking may be repeated as long as there are documents in the search index. An abstract is constructed including keywords with a group priority rating less than or equal to the user's relation rating and presented to the user. The abstract may include documents with the highest document rankings. A request may be received from the user for a document based on the abstract, either for a private document or a public document. If the request is for a public document, the document is presented to the user. If the request if for a private document, it may be presented in the user if the user has been granted viewing rights. If the user has not been granted viewing rights, the user may be redirected to submit a document request form.

### BACKGROUND

This application relates to searching, in particular searching web-searchable documents.

As the size of the documents posted on the Internet and transmittable via the Internet continues to grow, so does the amount of useful information stored and organized within user files. There are many data collections stored on servers and associated with one or more individuals. Examples of such data collections include online notes (such as Google Notebook), annotated albums of images (such as Flickr), and blogs.

Much of this data is used collaboration, but access to the data is restricted by rudimentary access control lists. Often, users wish to share this information in a collaborative manner but still want some level of control over its distribution. For example, a user may have an online notebook storing thoughts/opinions with regard to a particular website. The user may be willing to share this information with someone who finds it via a web search but may wish to have discrete control of its dissemination to others.

### SUMMARY

According to exemplary embodiments, methods for accessing web-searchable documents are provided. According to one embodiment, an Internet search query is received from a user, the query including at least one search term. A document in a search index of documents is analyzed, wherein keywords within the document are assigned group priority ratings. The user's relation rating to an owner of the document is determined, and the search term in the query is compared only to those indexed keywords within the document that have a group priority rating that is less than or equal to the user's relation rating to the owner of the document. An overall document ranking may be determined based on the comparison of the search term to the indexed keywords. The steps of analyzing a document, determining a user's relation rating, comparing the search term, and determining an overall document ranking may be repeated as long as there are documents in the search index. An abstract is constructed including keywords with a group priority rating less than or equal to the user's relation rating and presented to the user. The abstract may include documents with the highest document rankings. A request may be received from the user for a document based on the abstract, either for a private document or a public document. If the request is for a public document, the document is presented to the user. If the request is for a private document, it may be presented to the user if the user has been granted viewing rights. If the user has not been granted viewing rights, the user may be redirected to submit a document request form.

According to another embodiment, a method is provided for controlling document access. Keywords are parsed from a web-searchable document context to create a keyword list. For each keyword in the keyword list, a group priority rating is determined and assigned. For example, high group priority ratings are assigned to keywords that are sensitive or personal in nature, and low group priority ratings are assigned to keywords that are common an not sensitive or personal in nature. The group priority rating is indicative of a group of users that the document owner is willing to share the document with. The keywords with the associated group priority ratings are added to a search index. The group priority ratings control access to the documents in response to search queries from users.

Additional features and advantages are realized through the techniques of the present invention. Other embodiments and aspects of the invention are described in detail herein and are considered a part of the claimed subject manner. For a better understanding of the invention with advantages and features, refer to the description and to the drawings.

### BRIEF DESCRIPTION OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates exemplary assignment of user relation ratings;

FIG. 2 illustrates an exemplary method for group priority ratings assignment and indexing according to an exemplary embodiment;

FIGS. 3a and 3b illustrate an exemplary method for search and retrieval according to an exemplary embodiment; and

FIG. 4 illustrates an exemplary method for submitting a request form accordingly to an exemplary embodiment.

The detailed description explains exemplary embodiments, together with advantages and features, by way of example with reference to the drawings.

### DETAILED DESCRIPTION OF EMBODIMENTS

According to exemplary embodiment, a web-searchable document is analyzed for keywords. The keywords are assigned group priority level rights. Common words within the document (e.g., vacation, dog, etc.) may be assigned low priority group ratings, while less common, more sensitive, and person words (e.g., a person's name), may be assigned higher priority group ratings. When a user of a search engine performs a search, and a document (webpage) is found in response to the search, that user's relation rating to the document's owner is determined, and the terms in the search query are compared to those keywords within the document that have a priority rating that is less than or equal to the user's relation rating with respect to the document. owner. In this way, users have different search capabilities based on their relation to the owner of each document.

According to an exemplary embodiment, keywords are indexed differently than in typical search engines. Keywords are identified and parsed, and a group priority level or rating is determined for each keyword. The group priority level indicates how close a user must be to the document owner in order for that user'query to be compared with each keyword in the search index, i.e., what relation rating the user must have to the document owner in order to be presented with search results based on each keyword. Ideally, this will result in minimizing rejections of document requests in order to maximize the delivery of positive results. Therefore, the closer that user is to the document owner, the more keywords from the document will be available to match the user's search query (i.e., there is less “scrubbing” done by the system.).

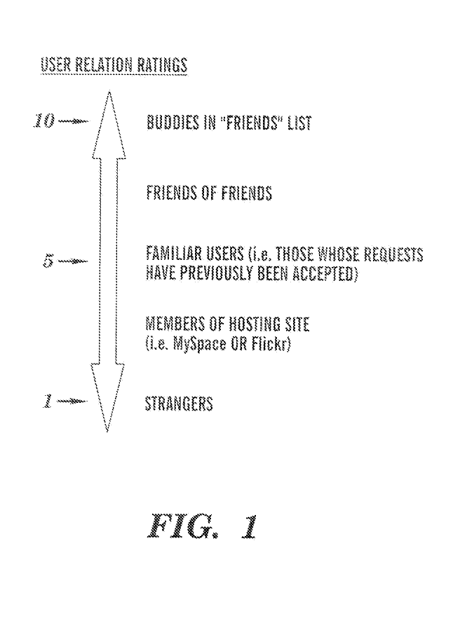

Referring to FIG. 1, different searchers may be given different relation ratings base on their relation to the document owner. For example, Buddies in a user's “friends” list may be given the highest relation ratings of “10”, while strangers may be given the lowest relation ratings of “1”. These relation ratings may be predetermined by the document owner or may be populated automatically based, e.g., on collaboration between the document owner and other users.

When a user performs a web search, that user's relation rating to each private document owner is determined, and the terms in the search query are compared to the keywords from the documents' index that have a priority rating that is less than or equal to the user's relation rating with regard to the document owner. In this way, users have different search capabilities based on their relation to the owner of each document. So, far example, a buddy “Kevin” may be able to find a document owner's Flickr vacation image in a search, whereas a complete stranger may not.

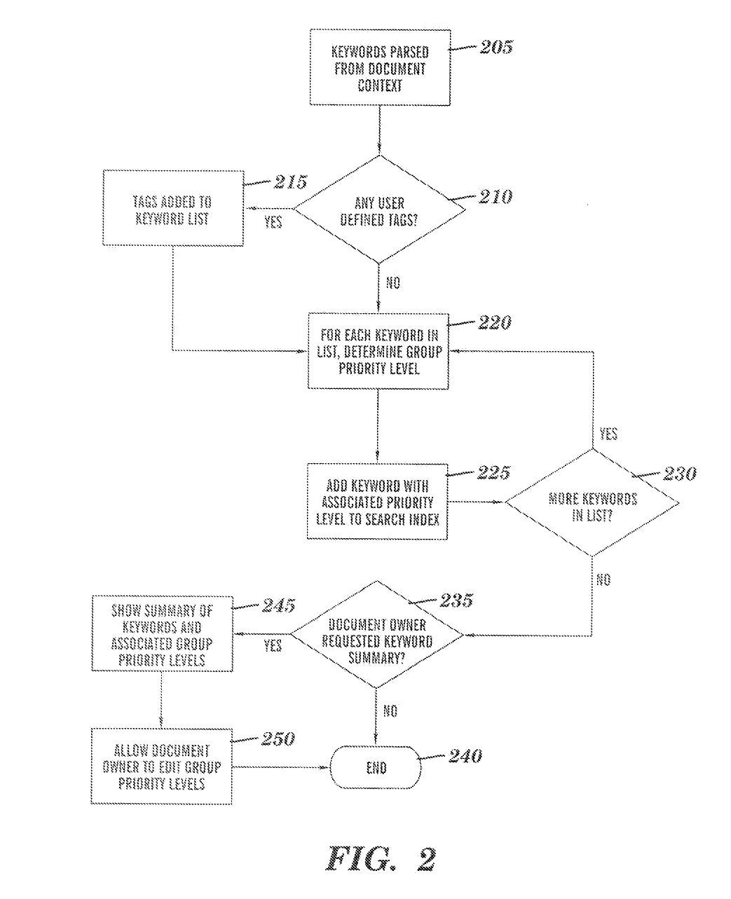

FIG. 2 illustrates a process for group priority level assignment and keyword indexing according to an exemplary embodiment. The process begins at step 205 at which keywords are parsed from the document context. A determined is made at step 210 whether there are any user-defined tags. If there are, the tags are added to a keyword list at step 215. At step 220, for each keyword in a list, a group priority rating is determined and assigned. At step 225, the keyword is added with the associated priority level to a search index. At step 230, a determination is made whether there are any more keywords in the list. If so, steps 220 and 225 are repeated. Otherwise, a determination is made whether the document owner requests a keyword summary at step 235. If not, the process ends at step 240. If the document owner does request a keyword summary, a summary of keywords and associated group priority levels may be presented to the document owner at step 245. The document owner may then be allowed to edit the group priority levels at step 250. Once editing is completed, the process ends at step 240.

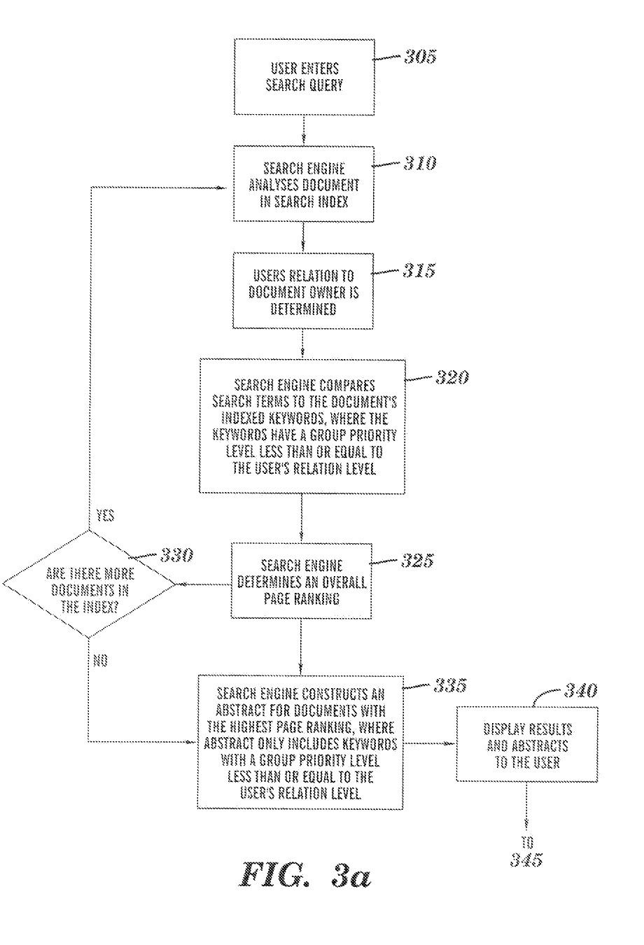

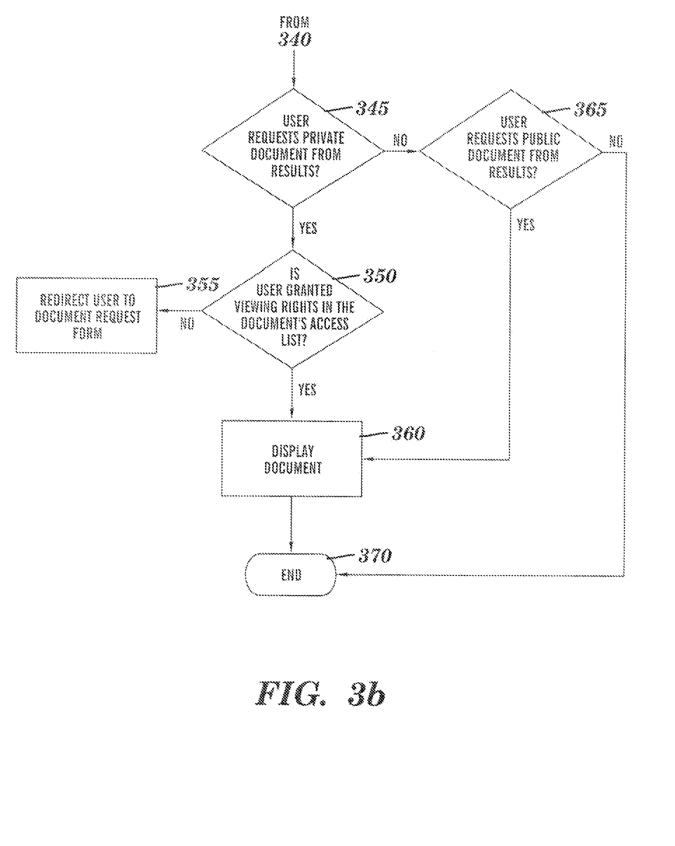

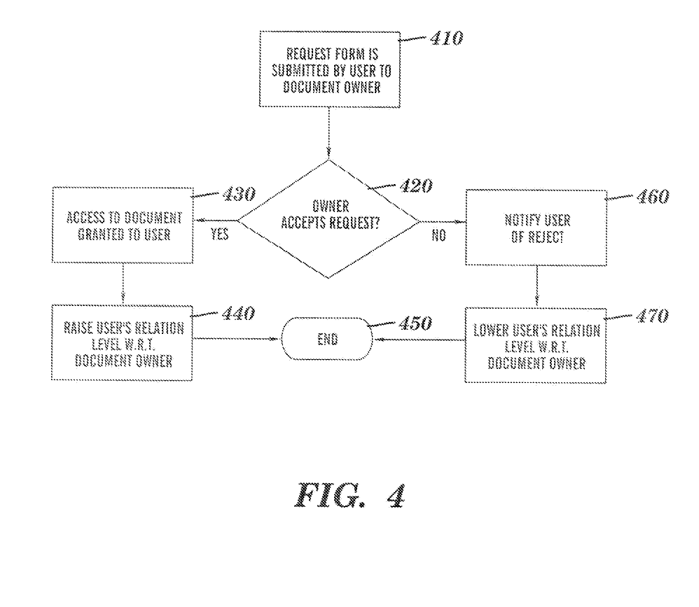

FIGS. 3a and 3b illustrate a search and retrieval process according to an exemplary embodiment. The process begins at step 305 at which a user enters a search query. At step 310, a search engine analyzes a document is a search index. At step 315, the user's relation to the document owner is determined. At step 320, a search engine compares the search terms to the document's indexed keywords, where the keywords have group priority level less than or equal to the user's relation level. A step 325, the search engine determines an overall page (document) rating. At step 330, a determination is made whether there are more documents in the index. If so, the process returns to step 310. Otherwise, the process continues to step 335 at with the search engine constructs an abstract for documents with the highest document rating. The abstract only includes keywords with a group priority level less than or equal to the user's relation level. At step 340, the results and abstract are presented to the user. From step 340, the process continues to step 345 at which a determination is made whether the user has requested a private document from abstract results. If so, a determination is made at step 350 whether the user is granted viewing rights in the document's accesses list. If not, the user is redirected to the document request from submission process (FIG. 4) at step 355. Otherwise, the document is displayed at step 360, and the process ends at step 370. If, at step 345 it is determined that the user has not requested a private document, a determination is made at step 365, whether the user requests a public document. If so, the document is displayed at step 360, and the process ends at step 370. If the user has not requested a public document, the process also ends at step 370.

FIG. 4 illustrates a process for submitting a request form according to an exemplary embodiment. This submission may be used if the user has requested a private document but was not granted viewing rights in the document's access list. At step 410, a request form is submitted by the user to the document owner. A determination is made at step 420 whether the user accepts the request. If not, the user may be notified of the rejection at step 460. Also, the user's relation with regard to the document owner may be lowered at step 470. If the owner does accept the request, access is granted to the user at step 430. The user's relation level with regard to the document owner may be raised at step 440. From steps 440 and 470, the process ends at step 450.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible medial, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, et., are used to distinguish one element from another. Furthermore, the use of the terms a, an, etc., do not denote a limitation of quantity, but rather denote the presence of at least one of the referenced item.

We claim:

1. A method of searching, comprising:
receiving an Internet search query from a user, the query including at least one search term;
analyzing a document in a search index of documents, wherein keywords within the document are assigned group priority ratings;
determining the user's relation rating to an owner of the documents;
comparing the search term in the query only to those indexed keywords within the document that have a group priority rating that is less than or equal to the user's relating rating to the owner of the document;
constructing an abstract to the user for the document, the abstract including keywords with a group priority rating less than or equal to the user's relation rating; and
presenting the abstract to the user.

2. The method of claim 1, further comprising determining an overall document ranking based on the comparison of the search term to the indexed keywords, and repeating the steps of analyzing, determining, comparing, and determining an overall document ranking as long as there are documents in the search index.

3. The method of claim 2, wherein the step of constructing an abstract includes constructing an abstract for documents with the highest document rankings.

4. The method of claim 1, further comprising receiving a request from the user for a document based on the abstract and determining whether the request is for a private document.

5. The method of claim 4, wherein if the request is not for a private document, a determination is made if the request is for a public document.

6. The method of claim 5, wherein if the request if for a public document, the document is presented to the user.

7. The method of claim 4, wherein each document is associated with an access list, and if the request is for a private document, a determination is made whether the user is granted viewing rights in the document's access list.

8. The method of claim 7, wherein if the user is granted viewing rights, the document is presented to the user, or if the user is not granted viewing rights, the user is redirected to submit a document request form.

9. A method of controlling document access, comprising:
parsing keywords from a web-searchable document context to create a keyword list;
for each keywords in the keyword list, determining and assigning a group priority rating, wherein the group priority rating is indicative of a group of users that the document owner is willing to share the document with; and
adding the keywords with the associated group priority rating to a search index, wherein the group priority ratings control access to the documents in response to search queries from users.

10. The method of claim 9, further comprising, after parsing keywords from the document context, determining whether there are any user defined tags and adding any use defined tags to the keyword list.

11. The method of claim 9, wherein high group priority ratings are assigned to keywords that are sensitive or personal in nature, and low group priority ratings are assigned to keywords that are common and not sensitive or personal in nature, the method further comprising allowing the document owner to edit group priority ratings.

12. A computer program product for searching comprising a computer usable medium having a computer readable program, wherein the computer readable medium, when executed on a computer, causes the computer to:
in response to receipt of an Internet search query from a user, the query including at least one search term, analyze a document in a search index of documents, wherein keywords within the document are assigned group priority ratings;
determine the user's relation rating to an owner of the document;
compare the search term in the query only to those indexed keywords within the document that have a group priority rating that is less than or equal to the user's relating rating to the owner of the document;
construct an abstract for the user of the document, the abstract including keywords with a group priority rating less than or equal to the user's relation rating; and
present the abstract to the user.

13. The computer program product of claim 12, wherein the computer readable medium further causes the computer to determine an overall document ranking based on the comparison of the search term to the indexed keywords and repeat the steps of analyzing, determining, comparing, and determining an overall document ranking as long as there are documents in the search index.

14. The computer program product of claim 13, wherein constructing an abstract includes constructing an abstract for documents with the highest document rankings.

15. The computer program product of claim 12, wherein the computer readable medium further causes the computer to, in response to receipt of a request from the user for a document based on the abstract, determine whether the request is for a private document.

16. The computer program product of claim 15, wherein if the request is not for a private document, a determination is made if the request is for a public document, and if the request is for a public document, the document is presented to the user.

17. The computer program product of claim 16, wherein each documents is associated with an access list, and if the request if for a private document, a determination is made whether the user is granted viewing rights in the doucument's access list.

18. The computer program product of claim 17, wherein if the user is granted viewing rights, the document if presented to the user, or if the user is not granted viewing rights, the computer readable medium further causes the computer to redirect the user to submit a document request form.

19. The computer program product of claim 13, wherein the keywords re indexed by parsing keywords from a web-searchable document context to create a keyword list, determining and assigning a group priority rating for each keyword in the keyword list, wherein the group priority rating is indicative of a group of users that the document owner is willing to share the document with, and adding the keywords with the associated group priority ratings to a search index, wherein the group priority ratings control access to the documents in response to search queries from users.

20. The computer program product of claim 19, wherein high group priority ratings are assigned to keywords that are sensitive or personal in nature, and low group priority ratings are assigned to keywords that are common an not sensitive or personal in nature.
